(19) United States
(12) Patent Application Publication
(10) Pub. No.: US 2005/0256856 A1
(43) Pub. Date: Nov. 17, 2005

(54) System for construction of algorithms to understand human behavior

(76) Inventors: Howard Moskowitz, White Plains, NY (US); Jacqueline Beckley, Denville, NJ (US); Hollis Ashman, Powell, OH (US)

Correspondence Address: Myers Dawes Andras & Sherman LLP;Suite 1150, 19900 MacArthur Blvd., Irvine, CA, 92612, US

(21) Appl. No.: 11/121,836

(22) Filed: May 2, 2005

Related U.S. Application Data
(60) Provisional application No. 60/566,850, filed on Apr. 30, 2004.

(51) Int. Cl. G06F 7/00

(52) U.S. Cl. 707/3

(57) ABSTRACT

A method of presenting stimuli and collecting rating data for understanding human behavior across a plurality of available topics. The method includes the steps of: designing a plurality of similarly constructed studies directed to a corresponding plurality of topics by creating a plurality of shared concept categories and, for each similarly constructed study, a plurality of concept elements that fit within the plurality of shared concept categories; presenting respondents with a plurality of available studies from amongst the plurality of similarly constructed studies; receiving a choice from the respondents as to a chosen topic of interest from amongst the plurality of available studies; presenting the respondents with a plurality of systematic combinations of concept elements (stimuli) relating to the chosen topic of interest; receiving a rating from the respondents for each combination of concept elements relating to the chosen topic of interest; and analyzing the respondents' ratings across the plurality of topics based on the respondents' ratings of concept elements contained in the shared concept categories.

### PRIORITY CLAIM

This patent application, pursuant to 35 USC 119, claims the benefit of U.S. Provisional Patent Application Ser. No. 60/566,850, filed on Apr. 30, 2004, entitled SYSTEM FOR CONSTRUCTION OF ALGORITHMS TO UNDERSTAND HUMAN BEHAVIOR, the entire contents of which are hereby incorporated by reference.

### FIELD OF THE INVENTION

This invention relates generally to the field of concept surveys and, more particularly, to a system or methodology for presenting stimuli and gathering consumer response data regarding similar concept elements relating to a plurality of different products or services.

### BACKGROUND OF THE INVENTION

The area of studying human behavior and its consequences is very large. Many disciples try to understand human behavior for a variety of reasons—humanitarian, political, etc. Recently, there has been a trend to use physiological measures such as MRI, synaptic mapping, etc to look into the brain and try to understand what parts of the brain are engaged when certain types of behaviors are being expressed (choice, gambling, trading stocks, eating ice cream, etc.). These efforts are further attempts at understanding human behavior and linking it to direct observation and measurement of electrical responses in the brain. These researchers are limited by the contextual impact of measuring the responses under tethered conditions (i.e. measuring responses while in an MRI, one has to think about performing the behavior), and are also limited by the volume and cost of people that can be measured over a set time period. Compared to this, what remains constant is the use of questionnaires and direct observations due to the ease with which these measurements can be taken in large numbers during a set time period, while the respondent is either thinking about or actual expressing the behavior.

Market researchers, for example, conduct various types of consumer research so that their employers or clients can make informed decisions regarding any number of issues concerning their products or services including, but not limited to, research and development (R&D), product features, packaging, and advertising.

Businesses want to be able to predict future scenarios that the consumer will react to so that they can structure their ongoing operations appropriately. Business would prefer that these future scenarios be structured in such a way as to be able to differentiate the impact of fads, trends and fundamental structural social changes. Unfortunately, humans do not appear in a lot of ways to function either logically or with any systematic behavior that is easily predictable. Nonetheless, the industry has taken several different approaches to trying to predict human behavior.

Collaborative filtering proposes algorithms to predict behavior and to predict what consumers might want as far as offers of purchase items go. Most collaborative filtering uses patterns of behavior, and similar patterns across many other individuals besides the individual in question. Collaborative filtering does not get at the reasoning behind the behavior, or at large-scale attitudes towards the many aspects of a product or service category. The use of artificial intelligence models and the statistical approach taken falls short in being able to deliver an understanding of behavior beyond the filters and frameworks of the model. This approach was hoped to be a solution for understanding humans, but has not proven to be so. The literature suggests research in this effort at many universities, at think groups within Microsoft, and commercially through a public company called Net Perceptions (NETP)

Double Click Inc. has developed push technology focused on advertising. However, due to the nature of their business, they do not cover the entire range of topics in human experience that our system covers, nor do they deal with attitudes. Like collaborative filtering, the Double Click Inc. approach deals with behaviors of a limited type.

Consumer research tracking studies attempt to find out what a person responds to in a single product category. These market-research procedures ask the respondent to identify their behaviors in a single category over the past year or so. The tracking studies do not deal with more than one or a limited number of categories. These are also self reported behaviors and are dependent on the level of self awareness that each respondent has about them selves.

Competitive regression attempts to use the methods and fundamental knowledge of psychology to link key consumer behavior (id, ego, self) to brands and product experiences. This is based on subjective expert understanding of the product experience and the impact of band and image on the psychological aspect for the consumer. Consumer archetypes are created to help understand the impact of changes in packaging, image and product to the psychological experience. This approach is limited due to the lack of quantitative and qualitative knowledge by the experts of the actual experience for the consumer.

“Concept tests,” especially those using conjoint measurement, attempt to identify the features of products or services that drive acceptance. Conjoint analysis measures the contributory value (“utility”) of components to a mixture based on measures of responses to a plurality of different mixtures, rather than direct measures of the specific components.

Generally speaking, concept research relates to the testing of various possible “concepts” regarding the product or service. In practice, the researcher presents the respondents with the concepts (stimuli) and solicits their responses to the concepts on a suitable rating scale (e.g. the 9-point hedonic scale, ranging from 1=“dislike extremely” to 9=“like extremely”). From start to finish, therefore, concept research involves the creation of the concepts, the presentation of the concepts to a number of consumer respondents and the related attainment of their responses, and the analysis of the responses on a respondent-by-respondent basis, or more typically, on an aggregate basis, in order to identify “winning” concepts and underlying patterns that will help the client make decisions relating to the product or service.

In a conjoint concept test, the concepts presented to the respondent are formed by systematically combining two or more concept elements. The respondent is presented with a plurality of such conjoint concepts and is asked to rate each such concept. The concept elements are usually written or visual statements about the products or services at issue. Examples of written concept elements include a simple declarative statement that describes a feature of the product or service (e.g. “100% natural coffee beans” for coffee), or one that describes a benefit of the product or service (e.g. “A jolt of caffeine to awaken your senses” for coffee). Examples of visual concept elements are background images, logos, and artwork for advertising or product packaging (e.g. a steaming cup of black coffee in a white china cup for coffee).

There are numerous ways to implement surveys, i.e. with paper and pencil questionnaires, with telephonic interviews, and with personal interviews, to name just a few. The internet, however, has made it especially convenient to design and present surveys, and to easily collect responses from a remotely located collection of respondents that are invited to take the survey by logging on to a particular website.

As early as 2001, Howard Moskowitz and others developed a PC-based system called Ideamap.Wizard. The Ideamap system allowed researched to prepare “self-authored” conjoint concept tests that could be administered to respondents sitting at the PC. Over time, the Ideamap system matured into server/client system that can be conveniently implemented via the internet.

The conjoint concept tests previously implemented on the Ideamap system were limited to the exploration of concepts relating to a single subject, topic, issue, product or service. A representative description of a single-topic conjoint analysis is contained within U.S. Pat. No. 6,662,215, the entire contents of which are hereby incorporated by reference.

While such single-topic tests provide valuable information, they are inherently narrow in their focus. Such tests, for example, can provide insight into the rational or emotional drivers underlying consumer interest in a particular product or service. However, there have been no large-scale, systematized conjoint measurement studies across a large number of related categories that span multiple subjects, topics, issues, products or services. The known testing systems, therefore, do not permit the researcher to quantitatively compare such diverse subjects as shopping behavior to interest in types of insurance or charitable gift giving. Qualitative judgments have been made across subject boundaries, but they have generally not been accurate or repeatable because of their qualitative nature.

Thus, the known prior art looks at one subject, topic, issue, product or category at a time and cannot compare subjects that appear to not relate (for example the measurement of anxiety in a multitude of life events and the ability to compare this to the craveability of food items). Because the known prior art cannot look broadly across subject areas that appear dissimilar, connections and linkages can never be measured uniformly or in a quantitative manner. This results in qualitative judgments, if any at all, that can not be systematically repeated. As a consequence, no underlying behavior patterns can be studied nor can underlying behavior linkages be understood. Due to this lack of common measures and an inability to create a general or macro-view across many aspects of life, the ability to compare issues, products, categories, or feelings that on the surface may appear dissimilar and unrelated does not and cannot occur.

There remains a need, therefore, for a structured research system or method that permits the researcher to structure the test and systematically capture human responses to one or more components of a broad life experience; to be able to understand that experience at the mega level (scanning across the landscape of the category); on an individual level (subject on either a subject or individual level); and on a time scaled level (looking at the impact of fads, trends and structural social changes) as these studies are completed across a set time period. There remains a need for a structured research system that can look from category to category (food, travel, giving, fear, protection, etc) and articulate specifically and quantitatively how experiences in different areas of life compare (e.g. why warranties can be like chocolate and therefore like a Starbucks Card).

### BRIEF SUMMARY OF THE INVENTION

In a first aspect, the invention may be regarded as a method of presenting stimuli and collecting rating data for understanding human behavior across a plurality of available topics, the method comprising the steps of: designing a plurality of similarly constructed studies directed to a corresponding plurality of topics by creating a plurality of shared concept categories and, for each similarly constructed study, a plurality of concept elements that fit within the plurality of shared concept categories; presenting respondents with a plurality of available studies from amongst the plurality of similarly constructed studies; receiving a choice from the respondents as to a chosen topic of interest from amongst the plurality of available studies; presenting the respondents with a plurality of systematic combinations of concept elements (stimuli) relating to the chosen topic of interest; receiving a rating from the respondents for each combination of concept elements relating to the chosen topic of interest; and analyzing the respondents' ratings across the plurality of topics based on the respondents' ratings of concept elements contained in the shared concept categories.

The preferred method is implemented via a computer interface and, more particularly, via a web-based server and related database and a plurality of client browsers operated by the respondents.

It is an object of the present invention to provide as true an understanding of the interconnectedness of human behavior as possible, since the approach makes the task manageable.

Prior to this, only small component parts of the life experience puzzle could be understood at anyone time.

It is an object of the present invention to improve the ability to understand the complexity of decision making.

It is an object of the present invention to improve the ability to measure complexity.

It is an object of the present invention to Increasing the robustness of understanding anomalies.

It is an object of the present invention to increases the chance to be more accurate with a theory and more specific with the reasons why.

It is an object of the present invention to decreases the time for understanding complex ideas.

It is an object of the present invention to explain observed behavior.

The just summarized invention may be better understood by reviewing the preferred embodiment disclosed in the following description and related drawings. It is understood that changes in the specific structure shown and described may be made within the scope of the claims, without departing from the spirit of the invention.

### BRIEF DESCRIPTION OF THE DRAWINGS

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below or illustrated in the figures, of which:

FIG. 1 is a conceptual chart showing the method according to a presently preferred embodiment of the invention that used to help understand and develop algorithms for human behavior across all areas of life; and

FIG. 2 is a flowchart showing the steps of the presently preferred method, the corresponding location of the noted steps identified with similar number on FIG. 1.

### DETAILED DESCRIPTION OF THE PREFERRED EMBODIMENTS

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims.

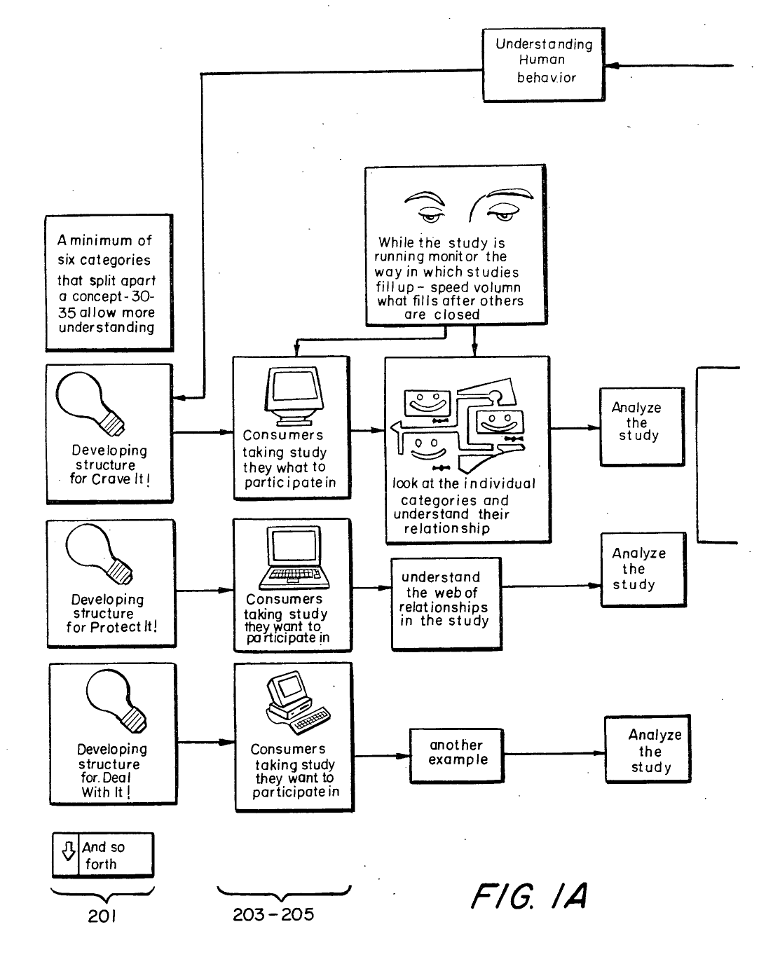

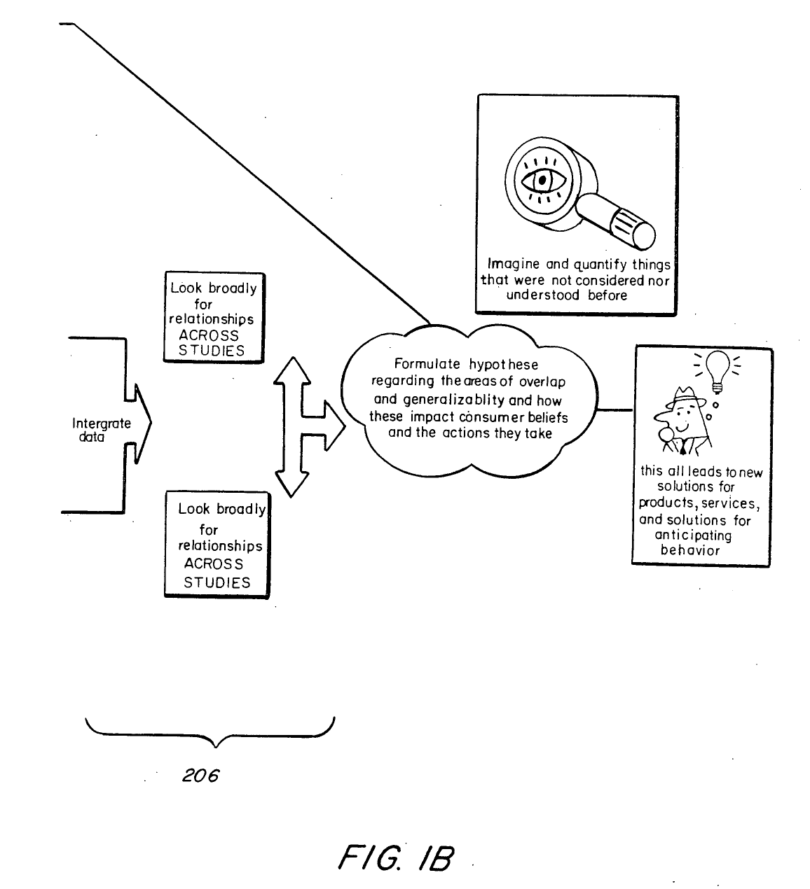

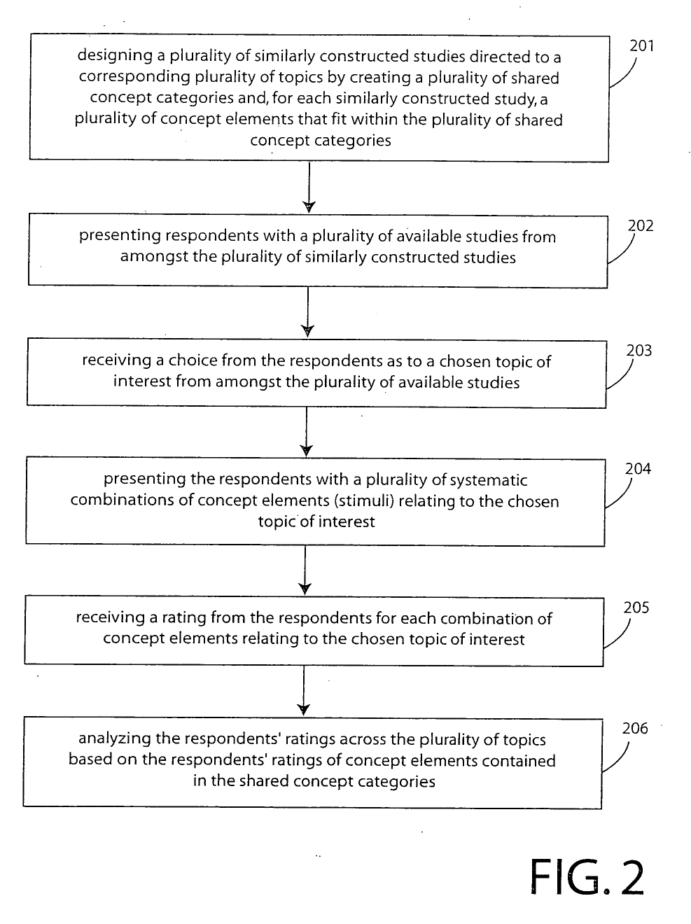

FIG. 1 illustrates a presently preferred approach of implementing a method according to this invention, the figure depicting the entire process we have developed to fully understand and develop algorithms for human behavior across all areas of life. FIG. 2 is a flow chart describing the steps of the preferred method. The steps of FIG. 2, numbered 201-206, are identified by similar numbers in FIG. 1.

Step one as represented by the light bulbs; focuses on the decision of the study topic to be construct and what fundamental question the study will address. The illustrations shows three different It! studies. What is proprietary to the work and was non-obvious prior to our effort was the design and structure of the study and how this would reveal information people were not aware of previously. For example, prior work on food craveability focused on high fat products such as chocolate and ice cream. The structure enabled the understanding that complex carbohydrate and protein based foods such as fresh fruits and meats could generate a craveable response similar to that of the expected high fat foods. The organization of the study with both the conjoint and supporting survey questionnaire is critical to this understanding and the eventual outcome of the work.

The study is then implemented on a computer. The ability for a respondent to select one study from a number of independent but linked, similarly constructed studies (viz., choices; different studies in which a respondent can participate) at one time for a given category is critical and was non-obvious when the work began. This type of data enables the understanding of self selected choice behavior that is much closer to actual behavior in the marketplace. Providing five or more choices on the screen has been important for understanding scale free networking of items in a collection of choices. This research is typically conducted with 30 to 35 choices (linked studies); however five choices or more begins to provide the insights that are part of this patent.

Mega-meta knowledge occurs as we observe and track which studies attract the most people first, which ones second, and so forth. Observing and tracking this over the series of studies (scale free networking) provides us with the hypotheses for the overarching linkages between categories of life (while operationally running each of the studies in the diagram and looking at the pattern of choice that emerges).

Meta knowledge comes from looking at the individual category studies (for example: Crave It!, Deal With It!, Protect It!). They are directed and organized for greater knowledge of human behavior when they are taken with the perspective of understanding the impact of fads, trends and underlying structural behavior across a time directed focus (i.e. across multiple time periods of measurement).

Mega knowledge comes from looking at a given subject in a given category of studies (for example: Mashed Potatoes in Crave It! or Homeowners insurance in Protect It!). When we look simultaneously as two or more studies, from different mega studies (e.g., mashed potatoes from Crave It!; Homeowners Insurance from Protect It!), and follow the results in both studies through to basic elements within each study (e.g., specific elements from mashed potatoes and homeowners insurance), then we can discover how elements in each of these two worlds (unique for the product, but fundamental) are quite similar in the role they play for their respective categories, and thus how these radically different categories (foods, insurance) are constructed. This type of learning cannot be obtained easily in any other way.

So what our invention does—it allows for the observation and analysis of the components of life experiences, to structure them, and measure them on a very broad basis, continue to watch what people do who interact with the components and then develop very robust algorithms for the reliable definition of what people do and why.

This system is more easily conducted due to the study development and data acquisition by means of the Internet and computers; however the process we define is a systematic way to structure life experiences, measure its components indirectly and directly and then describe why events or activities occur in a place or location. The system could be implemented with paper and pencil questionnaires, with personal interviews, and with keypunching to enter the data, and standard, off-the-shelf statistical analysis to analyze the data.

The invention is unique relative to the known prior art because it offers the following features:
1) Novel Approach to Research: Looking at multiple categories in the format we have looked at them has not and appears not be currently done in consumer research. The focus of consumer research, both business and academic, is on one problem and issue, within one product or service category
2) Novel Format Of Study Design: The entire system of categories, structure, a choice/pantry wall, measuring linkages and then using these as connectors across multiple categories is totally novel.
3) Novel Analysis—Formal The idea of running large studies with multiple categories using BOTH conjoint and survey research approaches is not obvious because the analysis of the data is not something that would be easy for most people to figure out. Most would not know how to structure and analysis the findings to provide actionable insights.
4) Novel Analysis—Worldview Of Research: The discipline and design that we have brought to this process is not common in the world. Few people attempt to understand categories a divergent as those categories we have looked at. Most people more narrowly focus on a specific category or industry. Until a person runs several of the foundations (e.g., foods, insurance, anxiety provoking situations), and analyzes the data across the studies, the ultimate pattern of choices to participate is not possible to understand. So, unless you have run these studies in the way we have outlined and completed and made these observations and made them repeatedly, you would not have the insight, data, and therefore unique knowledge.
5) Novel Use Of New Technology: Our approach is based upon a unique combination of questionnaires and conjoint analysis. Some of the newly developing technologies (e.g., self-authoring conjoint) have not been widely available to other people, so that the approach, straightforward to us, would not have been obvious to others unaware of the empowering capabilities of this new self-authoring technologies to facilitate our studies.

We are solving problems that no one else has been able to look broadly enough to solve. We understand the impact of complexity on life experiences. For example, with Crave It! we have identified three key mindset groups (Classic, Elaborate, Imagineer). So as we looked at the segments in other projects—like Drink It! and Professionalism—we looked for common mindsets and similar behavior—and since we have created principles that repeated themselves across a number of products and different categories we have hit upon some universal truths. Our mega-patterns studies (large, cross category segments) have been followed up with research using traditional methods as well, to see whether or not traditional methods could replicate or even discover this base knowledge. We found in the second year of our Crave It! study, for example, that many more people would self classify themselves with an Imaginers mindset than actually would select or purchase offers that were targeted to that group. In effect, the choice behavior was often times very different from the self-report data. This conflict between self-stated data (the conventional approach) and cross-category segmentation (based upon our approach) has huge implications for knowledge development and for application of this fundamental knowledge.

The mega studies enable an understanding of the difference between general fundamental behaviors from specific event or time related behaviors, and forces reconsideration of some common viewpoints that have been taken for granted. For example, craving is associated with chocolate, but not necessarily associated with other products like hamburgers or meat. Our results show that the craving for chocolate is very common but is not the most profound craving. What is more profound is the fact that fresh fruit, and some meats are more highly craved than chocolate. In fact chocolate is related to mood based craving, not overall craving. This is ‘new to the world’ learning that reorders our current knowledge, and significantly expands it. As a result we see that there is a lot of misunderstanding about behavior and motivations of people with regards to cravings for example and that have been translated into interpretation of human behavior that might actually be wrong—but this was the best that the science before our work could offer. (Analogy—until Mt St. Helene's erupted in 1980—volcanologist around the world had a very distinct set of mindsets about volcanic eruptions. There were also things they observed around the world that they could not really describe—so they developed theories that they thought were right. After the blast in May of 1980—the series of blasts and the sequence of events, all of volcanology changed and many of the theories we shown to be wrong—since the scientists had not experienced the situation—they really did not know and they made things up that were shown to be incorrect with the new information). Crave It!™ is showing us information about desire within humans which has never been documented on a scale like this before.

Learning in one mega study creates new insights in another mega study, leading to increased knowledge. The area of food—as studied in Crave It!™ (highly desired food)—can be used to discuss a lot of other topics and supply much deeper understanding of a category. For example—insurance, as a topic, is fairly difficult to understand. Using our system and having the Protect It!™ data (insurance life experience) and the Crave It!™ data (highly desired foods life experience), we can look at how the different categories within each topic area were selected (speed of choice, number of choice). This enables the hypothesis that home insurance behaves very much like mashed potatoes. Once this theory is considered—the question can be asked why is that? and how do we take these distinctly different products and compare the life experiences to understand them more deeply. The result is different selling/use opportunities for mashed potatoes and different ways to design home insurance for people. These types of interconnected life experience knowledge has lead to understanding for multiple companies of alternative business categories to mine for innovation, what components of the life experience can be utilized in another category to deliver a better life experience, fundamental human behaviors and their impact on specific product/brand and service experiences from a quantitative perspective not just a qualitative judgment.

More details regarding the preferred embodiment of the present invention are found in the 2003 ExplorAward submission attached hereto as an appendix.

Many variations are possible. For example, Instead of taking any category (shopping, food, grab & go food, electronics, banking, communications, gaming, etc.) and understanding components that make up the event, one can deconstruct one event and break that up into parts (for example studying the entire experience of a prom—this would involve categories of clothing, the evening, the party after, planning for the event, location, etc) so this system can be applied as narrowly or broadly as possible and will then allow for understanding linkages between a prom experience and golf experience for father/sons in Scotland). For example, we have taken the approach to looking at social issues (Deal With It!), and with donations for not for profit (Give It!). These are two areas that would not typically be dealt with in such a manner. These have enabled a broad understanding of the impact of social policy.

1. A method of presenting stimuli and collecting rating data for understanding human behavior across a plurality of available topics, the method comprising the steps of:
designing a plurality of similarly constructed studies directed to a corresponding plurality of topics by creating a plurality of shared concept categories and, for each similarly constructed study, a plurality of concept elements that fit within the plurality of shared concept categories;
presenting respondents with a plurality of available studies from amongst the plurality of similarly constructed studies;
receiving a choice from the respondents as to a chosen topic of interest from amongst the plurality of available studies;
presenting the respondents with a plurality of systematic combinations of concept elements (stimuli) relating to the chosen topic of interest;
receiving a rating from the respondents for each combination of concept elements relating to the chosen topic of interest; and
analyzing the respondents' ratings across the plurality of topics based on the respondents' ratings of concept elements contained in the shared concept categories.

2. The method of claim 1 further comprising the step of monitoring the topics that are chosen by the respondents from amongst the plurality of available studies.

3. The method of claim 2 further comprising the step of analyzing the order of which topics are chosen by the respondents.

4. The method of claim 3 wherein a study is removed from the plurality of available studies after a predetermined number of respondents have completed the study.

5. The method of claim 1 further comprising the step of analyzing the frequency with which topics are chosen by the respondents.

6. The method of claim 1 further comprising the step of analyzing the respondents' ratings of concept elements relating to individual ones of the plurality of topics according to conjoint analysis techniques.

7. The method of claim 1 wherein the number of shared concept categories is 4 and the number of concept elements that fit within the 4 concept categories is 9.

8. The method of claim 1 wherein the concept elements are textual.

9. The method of claim 1 wherein the concept elements are graphical.

10. The method of claim 1 wherein the concept elements are both textual and graphical.

11. The method of claim 1 wherein the presenting and receiving steps are accomplished via a computer interface.

12. The method of claim 11 wherein the presenting and receiving steps are accomplished via web-based server and related database and a plurality of client browsers operated by the respondents.
